(19) United States
(12) Patent Application Publication
(10) Pub. No.: US 2025/0332584 A1
(43) Pub. Date: Oct. 30, 2025

(54) DOOR ARRANGEMENT FITTED TO A FIRST ENCLOSED SPACE FOR REDUCING CONTAMINATION RISKS WHEN A SECOND ENCLOSED SPACE IS CONNECTED TO THE FIRST ENCLOSED SPACE

(71) Applicant: ABC Transfer, Tours (FR)

(72) Inventors: Julien FELIX, Tours (FR); Jean-Luc Schneider, Sligo (FR); Thierry Girard, Tours (FR)

(21) Appl. No.: 19/255,690

(22) Filed: Jun. 30, 2025

Related U.S. Application Data
(63) Continuation of application No. 17/787,468, filed on Jun. 20, 2022, now abandoned.

(30) Foreign Application Priority Data
Dec. 20, 2019 (FR) 1915247

(51) Int. Cl. B01L 1/02; E05B 65/00; E05C 3/12; G21F 7/005; G21F 7/047

(52) U.S. Cl. CPC B01L 1/02; E05B 65/006; G21F 7/005; B01L 2300/041; E05C 3/12; E05Y 2201/624; G21F 7/047

(57) ABSTRACT

The invention relates to a door arrangement (1) for a first enclosed space enabling a sealed connection between the first enclosed space and a second enclosed space, comprising a flange (2) defining an opening into the first enclosed space, a door (4) hingedly mounted on the flange (2), means for securing the flange of the second space pressed against the flange of the first space, the means comprising locking catches (8) which are movable between an unlocked position in which they are recessed inside the flange (2) and a locked position in which they project radially from the flange (2) to the opening, thereby locking the flange of the second space without rotating the flange (2) by engaging each catch in a notch provided on the outer peripheral edge of the flange of the second space.

### CROSS REFERENCE TO RELATED APPLICATION

This application is a continuation of U.S. application Ser. No. 17/787,468, filed Jun. 20, 2022, which is a U.S. National Phase of International Application No. PCT/FR2020/052498, filed Dec. 17, 2020, which claims priority to French Patent Application No. FR1915247, filed Dec. 20, 2019, all of which are incorporated by reference herein in their entirety.

### TECHNICAL FIELD OF THE INVENTION

The present invention relates to a door arrangement intended to be fitted to a first enclosed space and able to allow a sealed connection of a second enclosed space to the first enclosed space.

The present invention relates more particularly to a door arrangement fitted to a first enclosed space, comprising a flange defining a passage opening into the first enclosed space, an axis door hingedly mounted on the flange so as to pass between a closed position, in which the door closes the passage opening, and an open position, securing means capable of securing and maintaining the flange of the second enclosed space pressed against the flange of the first space.

In the present application, “space” means any product, equipment or installation delimiting a space. Thus, it can be an enclosure, an insulator, a receptacle, a container, a bag, etc.

“Enclosed space” is understood to mean a space isolated from the external environment. This may be in particular, but not exclusively, a space for preparing, storing and/or handling products that must not be in contact with the outside or with a user.

The door arrangement is intended in particular, but not exclusively, to connect two enclosed spaces in order to transfer products from one space to the other without breaking the containment. This may include, for example, the transfer of hazardous products such as certain biological, chemical or radioactive products, the transfer of components such as stoppers, vials, plungers, syringes, etc., the transfer of environmental control devices such as culture medium plates, particle counters, etc., the transfer of cleaning systems, the transfer of liquids, powders, tools, the transfer of waste to the outside of the enclosure and/or the transfer of any element necessary to production or maintenance of the production line.

### PRIOR ART

The transfer of products from one enclosed space to another without breaking the containment of these spaces is a difficult problem to solve. To respond to this problem, double-door sealed connection devices have been developed. This includes, for example, those described in patent applications FR2777822 and FR3036054.

These double-door connection devices are formed by a first and a second door/flange assembly, one of the door/flange assemblies being that of one of the spaces, the other door/flange assembly being that of the other space. Conventionally, the enclosed space to be connected is a receptacle of the transportable container or pouch type, while the other enclosed space to which the receptacle is connected is generally a fixed handling enclosure. The receptacle is connected to the handling enclosure by connecting the door/flange assemblies together. This connection is generally achieved by engaged what is referred to as a bayonet system-male lugs of the flange and the door of the receptacle engaging, respectively, in notches of the flange and the door of the handling enclosure-followed by a rotation of the receptacle, which allows the flange of the receptacle to be locked to the flange of the handling enclosure, as well as allowing the door of the receptacle to be locked to the door of the enclosure, the doors connected to one another being unlocked by unlocking the doors from the respective flanges thereof.

The friction generated between the flanges and doors during the rotational movements performed to lock the flanges and doors to one another, to unlock the doors from their associated flanges or to unlock the spaces from one another have the disadvantage of producing particles likely to cause contamination within the enclosed spaces, but also to produce a break in the sealing of the connection.

The invention aims to remedy this drawback by proposing a door arrangement preventing, or at least limiting, the emission of particles liable to generate contamination of the enclosed spaces when they are connected.

Another object of the invention is to provide a door arrangement limiting turbulence under laminar flow when the door is opened, turbulence being a source of contamination risks during the transfer process.

### SUBJECT MATTER OF THE INVENTION

To this end, the invention proposes a door arrangement for a first enclosed space enabling a sealed connection between said first enclosed space and a second enclosed space, comprising a flange arranged to define a passage opening in the first enclosed space, the passage opening defining an opening plane and a passage axis perpendicular to the opening plane, a door hingedly mounted on the flange so as to pass between a closed position, in which the door closes the passage opening, and an open position, securing means capable of securing and maintaining the flange of the second enclosed space pressed against the flange of the first space, the arrangement being remarkable in that the securing means comprise locking catches movable between an unlocked position in which they are recessed within the flange and a locked position in which they project radially from the flange toward the passage opening, thus locking the flange of the second enclosed space without rotational movement of said flange by engaging each catch in a notch provided on the outer peripheral edge of the flange of the second space.

This arrangement of the securing means thus allowing elimination of the rotational movement imposed with the joining devices of the prior art to connect the flanges to one another, thus limiting the friction between the two spaces when they are connected to one another and therefore the production of contamination-generating particles.

Advantageously, each locking catch is driven by a micromotor formed at the outer face of said flange.

Advantageously, the micromotors are associated with means for detecting the presence of the flange of the second space against the flange of the first space.

Advantageously, the door is fixed to the flange by means of a double-jointed link mechanism comprising a first joint arranged to allow rotational movement about an axis perpendicular to the passage axis of at most 30 degrees relative to the plane of the passage opening and a second joint arranged to allow rotational movement about an axis parallel to the passage axis.

Advantageously, the second joint is arranged to allow a rotational movement, preferably of 180 degrees, relative to the plane of the passage opening.

Advantageously, the double-jointed link mechanism is coupled to a micromotor located in the connection arm.

### BRIEF DESCRIPTION OF THE DRAWINGS

Other features and advantages of the invention will become apparent from the following detailed description of the invention with reference to the appended figures, in which:

FIG. 1 shows a rear perspective view of a door arrangement according to the invention in the closed position;

FIG. 2a shows a front view of the door of the arrangement of FIG. 1, in the closed position;

FIG. 2b shows a top view of the door of the arrangement of FIG. 1, in the closed position;

FIG. 3a shows a front view of the door of the arrangement of FIG. 1, in the intermediate open position;

FIG. 3b shows a top view of the door of the arrangement of FIG. 1, in the intermediate open position;

FIG. 4a shows a front view of the door of the arrangement of FIG. 1, in the intermediate open position;

FIG. 4b shows a top view of the door of the arrangement of FIG. 1, in the intermediate open position;

FIG. 5a shows a front view of the door of the arrangement of FIG. 1, in the fully open position;

FIG. 5b shows a top view of the door of the arrangement of FIG. 1, in the fully open position;

FIG. 6 shows a front perspective view of the door of the arrangement of FIG. 1, in the closed position;

FIG. 7a shows a detail view of a flange locking catch in an unlocked state of the flange;

FIG. 7b shows the flange locking catch of FIG. 7a in locked state of the flange.

FIG. 8 shows a front perspective view of the door of the arrangement of FIG. 1, in the closed position, the door being in the position secured to the door of the second enclosed space.

Hereinafter, the term “rear view” or “view from the rear” designates the view that is in or directed toward the interior space of the enclosed space defined by the door arrangement. Similarly, the term “front view” in relation to an enclosed space means that which is located outside the inside space of the enclosed space or directed away from the inside of the enclosed space defined by the door arrangement.

### DETAILED DESCRIPTION OF THE INVENTION

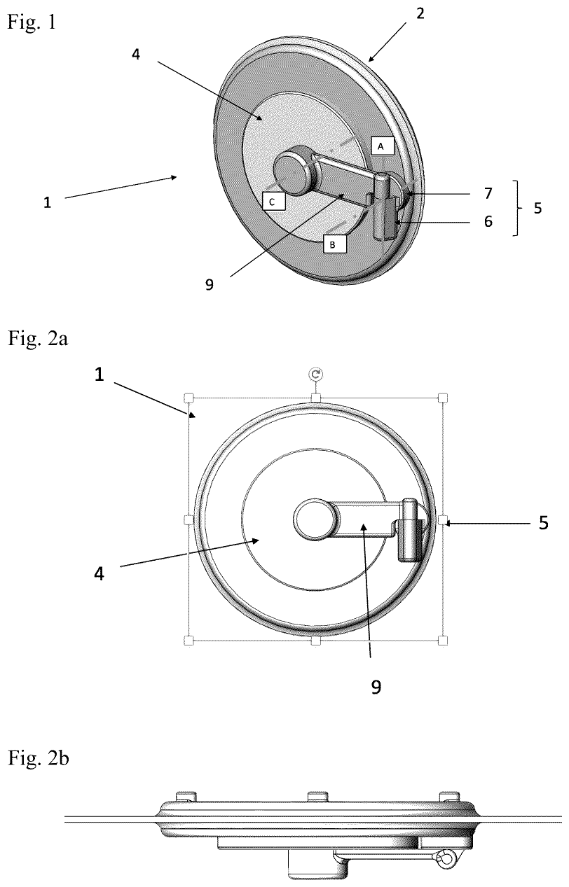

In connection with FIGS. 1 to 8, there is described a door arrangement 1 equipping a first enclosed space. This door arrangement is arranged to allow the connection of a second enclosed space. According to a particular embodiment, the first enclosed space is a fixed enclosure while the second enclosed space is a transportable container. This is of course one embodiment, the device according to the invention not being limited to this type of enclosed space. The door arrangement of the first space and the door arrangement of the second space form, when they are connected to each other, a sealed function device allowing the transfer of products between the two enclosed spaces, without breaking the containment.

The door arrangement 1 according to the invention comprises a flange 2 and a door 4. The flange 2 is arranged to delimit a passage opening 3 in the enclosure provided with the door arrangement 1, the passage opening 3 defining an opening plane and a passage axis perpendicular to the opening plane. The door 4 is hingedly fixed on the flange 2 so as to pass from a closed position, in which the door 4 closes the passage opening 3, to an open position, in which the door 4 extends substantially parallel to the passage opening plane, and vice versa. To do this, the door is fixed on the flange by means of a double-jointed link mechanism 5. The latter thus comprises a first joint 6 arranged to allow a rotational movement about an axis A perpendicular to the axis C of the door (or to the axis of the passage opening) on the one hand and a second joint 7 arranged to allow a rotational movement about an axis B parallel to the axis C of the door (or to the passage axis of the passage opening) on the other hand (FIG. 1). In the present description, the term “axis of the door” denotes the axis that extends perpendicularly to the door when the latter is in the closed position. The axis of the door therefore corresponds to the passage axis of the passage opening 3. The axis C shown in FIG. 1 will subsequently designate either the axis of the door in the closed position or the passage axis.

The two joints 6 and 7 are arranged with the door 4 so that the opening of the door takes place firstly following the rotational movement about the axis A, then secondly following the rotational movement about the axis B. The first joint 6 is in the form of a hinge, the fixed part of which is secured to the second joint 7, which in turn is coupled to the door by a connection arm 9.

The first joint 6 is arranged to allow a rotational movement of at most 30 degrees relative to the plane of the opening, while the second joint 7 is arranged to allow a rotational movement of at least 45 degrees, and preferably 180 degrees relative to the plane of the opening.

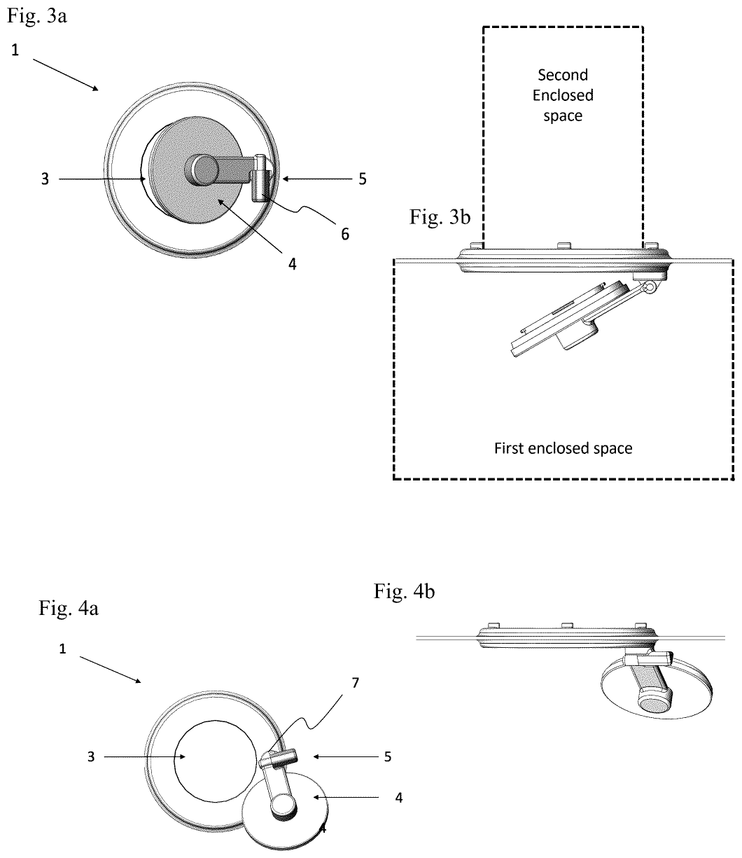

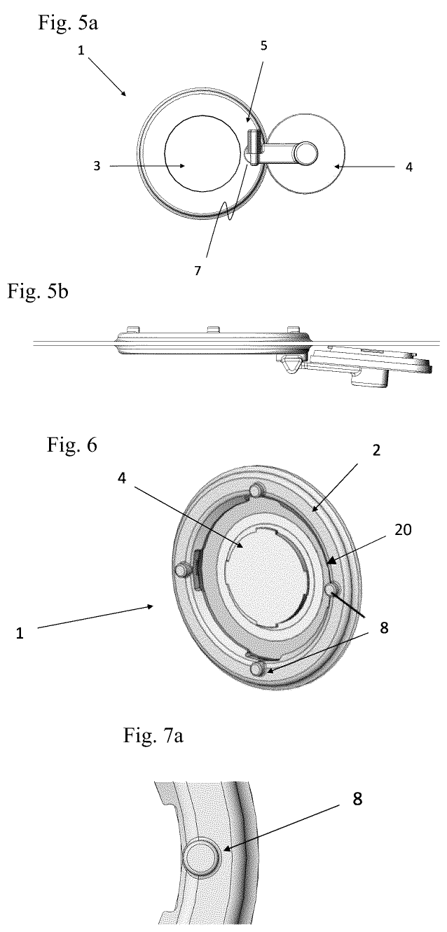

FIGS. 2 to 5 illustrate the rotational movements of the door performed to pass from a closed position to an open position. Thus, the opening of the door 4 takes place, from its closed position (FIG. 2), by rotation about the axis A of the hinge (first joint 5) following a stroke of approximately 20 degrees in the example illustrated (FIG. 3). The door 4 is then in a partially open position. The door 4 is then actuated to move in rotation about the axis B of the second joint 7 over a stroke of approximately 180 degrees to reach the final open position illustrated in FIG. 5 passing through intermediate opening positions providing complete clearance of the passage opening 3 (FIG. 4 shows the door in an intermediate opening position). In its final position, the door extends in a plane parallel to the plane of the passage opening, diametrically opposite its closed position.

According to an advantageous embodiment, the door is advantageously motorized. To do this, the first and second joints 6, 7 are each coupled with a motor of the stepping type, for example. It is of course obvious that the invention is not limited to a motorized door, the movement of the latter being able to be carried out manually by actuating a control lever borne by the door, this control lever being able to be provided on the interior side and/or exterior side of the enclosed space.

As indicated previously, the door arrangement according to the invention allows the coupling of a second space provided with a second flange that defines a passage opening in the second enclosed space and closed by a second door. For this purpose, the flange 2 advantageously has an outer face 20 provided with securing means capable of securing and maintaining the flange of the door of the second enclosed space pressed against it. In the illustrated embodiment, the fastening means of the flange comprise magnetic locking catches 8. It is of course obvious that this is an example embodiment and that other locking means can be implemented, such as for example actuators, without departing from the scope of the invention.

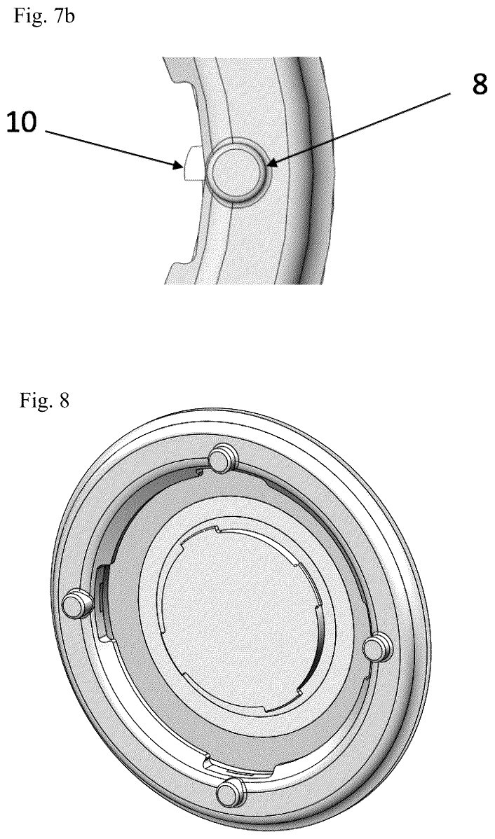

Each locking catch 8 is provided with a locking lug 10 movable between a position in which the lug is recessed within the flange and a position in which the lug projects radially from the flange 2 toward the passage opening, thus locking the flange of the second enclosed space. Furthermore, each locking catch 8 is associated with a micromotor able to drive them in rotation to make them pass from their unlocked state to their locked state. FIGS. 7a and 7b show a catch in its unlocked position and its locked position.

In the illustrated embodiment, the flange is provided with four locking catches 8 distributed at 90 degrees. This is of course an example embodiment; the number of locking catches may vary according to the dimensions of the door. The flange thus comprises at least two locking catches, advantageously located diametrically opposite one another.

According to FIG. 8, the door 4 performs a rotation about the axis C (advantageously) 60° to unlock the door of the second enclosed space from the flange thereof and to secure the door of the second enclosed space with the door 4. In the illustrated embodiment, the door is driven by a motor located in the connection arm 9.

The invention is described in the foregoing by way of example. It is understood that a person skilled in the art is in a position to produce various variant embodiments of the invention without thereby departing from the scope of the invention.

1. A door arrangement of a first enclosed space allowing a sealed connection between said first enclosed space and a second enclosed space, comprising
a first flange arranged to define a passage opening in the first enclosed space, the passage opening defining an opening plane and a passage axis perpendicular to the opening plane;
a first door hingedly mounted on the first flange so as to pass between a closed position, in which the door closes the passage opening, and an open position; and
securing means for securing and maintaining a second flange of the second enclosed space pressed against the flange of the first space;
characterized in that the securing means comprise locking catches movable between an unlocked position in which they are recessed within the first flange and a locked position in which they project radially from the first flange toward the passage opening, thus locking the second flange of the second enclosed space without rotational movement of said flange by engaging each catch in a notch provided on an outer peripheral edge of the flange of the second space, when the first and second enclosed spaces are connected to each other.

2. The door arrangement according to claim 1, characterized in that each locking catch is driven by a micromotor formed at the outer face of said flange.

3. The door arrangement according to claim 2, characterized in that the micromotors are associated with means for detecting the presence of the flange of the second space against the flange of the first space.

4. The door arrangement according to claim 1, characterized in that the door is fixed to the flange by means of a double-jointed link mechanism comprising a first joint arranged to allow rotational movement about an axis perpendicular to the passage axis of at most 30 degrees relative to the plane of the passage opening and a second joint arranged to allow rotational movement about an axis parallel to the passage axis.

5. The door arrangement according to claim 4, characterized in that the second joint is arranged to allow a rotational movement, of up to 180 degrees, relative to the plane of the passage opening.

6. The door arrangement according to claim 4, characterized in that the double-jointed link mechanism is coupled to a micromotor located in a connection arm.

7. The door arrangement according to claim 2, characterized in that the door is fixed to the flange by means of a double-jointed link mechanism comprising a first joint arranged to allow rotational movement about an axis perpendicular to the passage axis of at most 30 degrees relative to the plane of the passage opening and a second joint arranged to allow rotational movement about an axis parallel to the passage axis.

8. The door arrangement according to claim 3, characterized in that the door is fixed to the flange by means of a double-jointed link mechanism comprising a first joint arranged to allow rotational movement about an axis perpendicular to the passage axis of at most 30 degrees relative to the plane of the passage opening and a second joint arranged to allow rotational movement about an axis parallel to the passage axis.

9. The door arrangement according to claim 7, characterized in that the second joint is arranged to allow a rotational movement, of up to 180 degrees, relative to the plane of the passage opening.

10. The door arrangement according to claim 8, characterized in that the second joint is arranged to allow a rotational movement, of up to 180 degrees, relative to the plane of the passage opening.

11. The door arrangement according to claim 7, characterized in that the double-jointed link mechanism is coupled to a micromotor located in the connection arm.

12. The door arrangement according to claim 8, characterized in that the double-jointed link mechanism is coupled to a micromotor located in the connection arm.

13. The door arrangement according to claim 5, characterized in that the double-jointed link mechanism is coupled to a micromotor located in the connection arm.

14. The door arrangement according to claim 9, characterized in that the double-jointed link mechanism is coupled to a micromotor located in the connection arm.

15. The door arrangement according to claim 10, characterized in that the double-jointed link mechanism is coupled to a micromotor located in the connection arm.
